(19) United States
(12) Patent Application Publication
(10) Pub. No.: US 2016/0065729 A1
(43) Pub. Date: Mar. 3, 2016

(54) DUAL-SOURCE HYBRID CANCELLATION SCHEME

(71) Applicant: Ikanos Communications, Inc., Fremont, CA (US)

(72) Inventor: James T. Schley May, Nevada City, CA (US)

(21) Appl. No.: 14/843,149

(22) Filed: Sep. 2, 2015

Related U.S. Application Data
(60) Provisional application No. 62/044,729, filed on Sep. 2, 2014.

(51) Int. Cl. H04M 3/18; H04L 25/02

(52) U.S. Cl. CPC H04M 3/18; H04L 25/0266

(57) ABSTRACT

Embodiments of the invention relate to methods and apparatuses for performing hybrid rejection that overcome various shortcomings of the prior art. In one embodiment, the transformer's receive winding is stacked on top of the transmit winding, the two being wired in series and in phase. Z2 is scaled by approximately half so as to maintain the same receive gain. In another embodiment, rather than stacking the receive and transmit windings for series summation, they are each used as independent sources into the summing junction of the receive amp. If Z2 and Z3 are equal, then an equal proportion of V1 and V2 are summed.

### CROSS-REFERENCE TO RELATED APPLICATIONS

This application claims the benefit under 35 USC 119(e) of prior co-pending U.S. Provisional Patent Application Ser. No. 62/044,729, filed Sep. 2, 2014, the disclosure of which is hereby incorporated by reference in its entirety.

### FIELD OF THE INVENTION

The present invention relates to telecommunications, and more particularly to methods and apparatuses for performing dual-source hybrid cancellation.

### BACKGROUND OF THE RELATED ART

In the field of telecommunications such as xDSL, a hybrid circuit, also known as a two-to-four wire converter circuit, is used to couple the analog transmit and receive signals to and from the phone line. The hybrid circuit has three ports: transmit, receive, and line. One of the requirements of the hybrid circuit is to cancel the transmit signal in the receive port. This is known as trans-hybrid rejection.

At least one transformer is required to galvanically isolate the transceiver circuitry from the line. The transformer is typically comprised of several windings around a single core. The transformer's leakage inductance and parasitic capacitance degrade the ability of the hybrid circuit to provide optimum hybrid rejection at high frequencies.

Therefore it would be advantageous to find a way to improve the hybrid rejection, especially if the incremental cost was zero or almost zero.

### SUMMARY OF THE INVENTION

Embodiments of the invention relate to methods and apparatuses for performing hybrid rejection that overcome various shortcomings of the prior art. In one embodiment, the transformer's receive winding is stacked on top of the transmit winding, the two being wired in series and in phase. Z2 is scaled by approximately half so as to maintain the same receive gain. In another embodiment, rather than stacking the receive and transmit windings for series summation, instead they are each used as independent sources into the summing junction of the receive amp. If Z2 and Z3 are equal, then an equal proportion of V1 and V2 are summed.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 shows a typical hybrid circuit, simplified.

FIG. 2 shows a more realistic model, with the internal leakage inductance of the transformer shown as Zleak.

FIG. 3 shows a commonly used variation of FIG. 2.

FIG. 4 shows one solution, and is one aspect of the current invention.

FIG. 5 shows another solution and is another aspect of the current invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

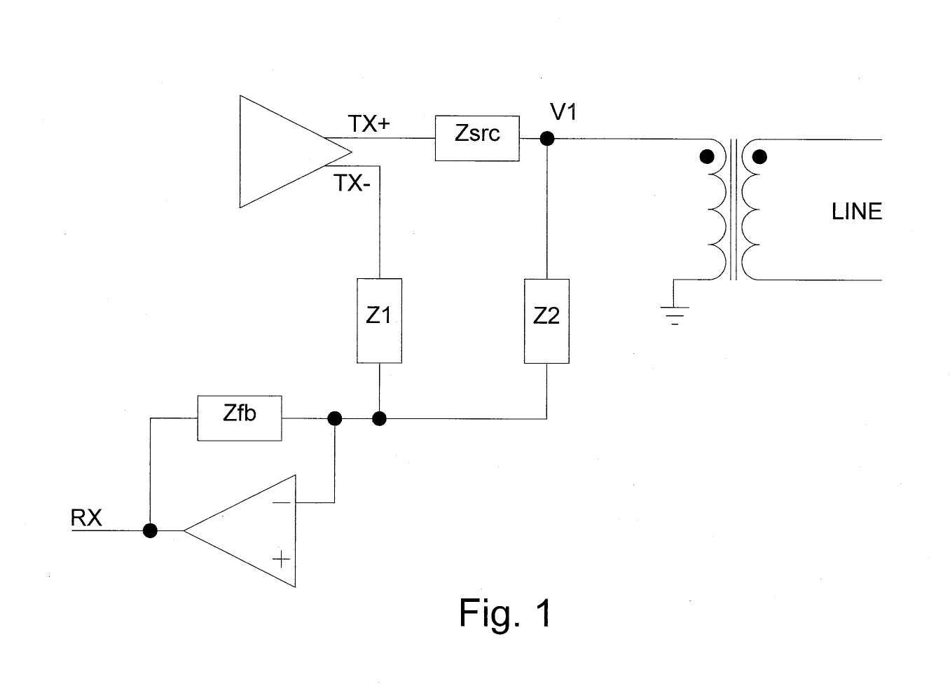

Most if not all hybrid circuits are balanced differential circuits. But for purposes of explanation, it is easier to show the single-ended equivalent circuit. FIG. 1 shows a typical hybrid circuit, simplified.

TX+ drives the transformer through back matching impedance Zsrc. Assuming Zsrc approximately matches the line impedance as reflected through the transformer, then V1 equals about half of TX+. V1 is picked up and amplified by the receive amp with a gain of Zfb/Z2. Z1 and Z2 are scaled to be much higher than Zsrc and the line impedance so as to effectively not load the circuit. In order to cancel the transmit signal at RX, the opposite polarity TX− is also summed into the receive amplifier via Z1 which is scaled approximately twice that of Z2.

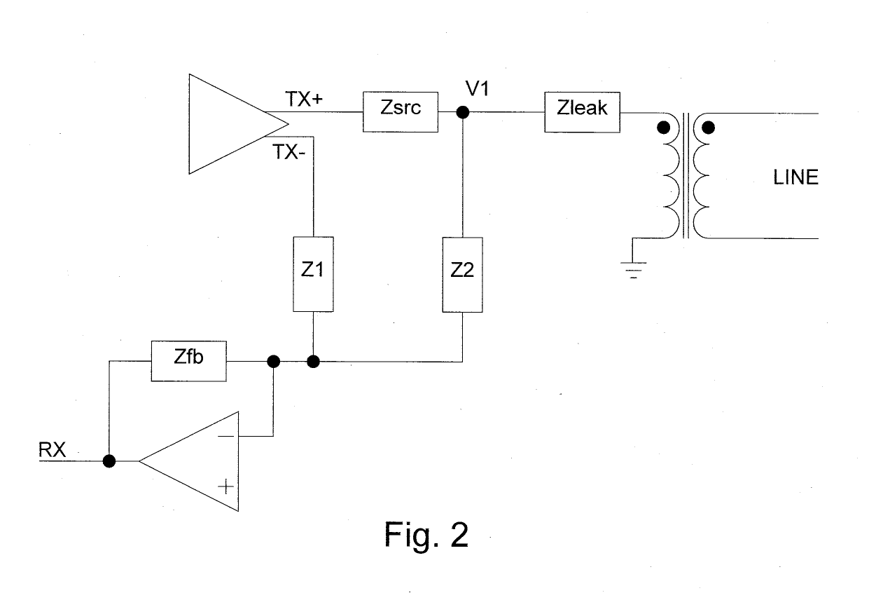

FIG. 2 shows a more realistic model, with the internal leakage inductance of the transformer shown as Zleak.

At higher frequencies, the leakage inductance Zleak presents extra impedance in series with the line as seen through the transformer. As a result, V1 grows (tilts up) as the frequency increases. Both magnitude and phase increase, whereas TX is fixed and therefore flat. This causes the hybrid rejection to degrade at higher frequencies. In contrast to that tilt, the transmit signal on the line droops at high frequencies because of the extra impedance Zleak in series with the transformer.

One solution to this problem is to add inductance equivalent to Zleak into the Zsrc impedance. That would counter the effect. But there are two problems with that approach: the exact amount of leakage inductance in a given transformer is difficult to control, and inductors are expensive, especially ones with the high linearity required, and it would further increase the inaccuracy of the impedance seen by the line by adding yet more inductance in series with the back match load.

Another partial solution is to adjust Z1 and Z2 to try and counter the effect of Zleak, but it suffers from most of the same problems as described above. Both are poor solutions.

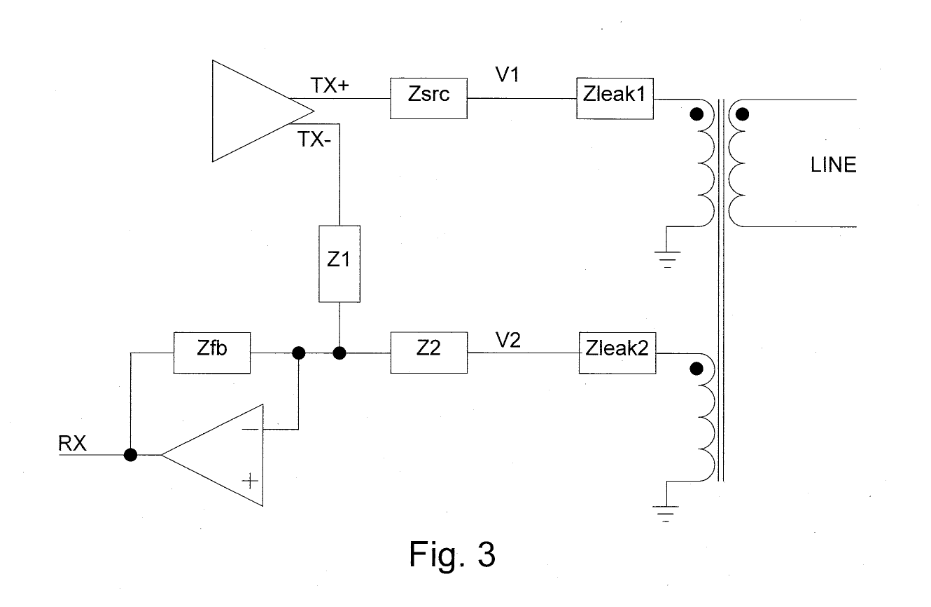

FIG. 3 shows a commonly used variation of FIG. 2.

A separate receive winding is added to the transformer, which has very little associated cost. For purposes of simplifying the discussion, assume the receive winding has the same number of turns, and Zleak1 approximately equals Zleak2. In practice it may be advantageous to scale the receive winding differently than the transmit winding, but the principals being discussed still apply.

As previously stated, during transmit, V1 tilts up at high frequencies due to Zleak1, and the signal on the line droops at high frequencies.

The voltage appearing at the receive winding mirrors the droop seen on the line. Therefore, during transmit, V2 droops at high frequencies with respect to TX+ (which is the flat reference). In practice the phase droop is more pronounced than the magnitude droop, but both matter. Like the circuit in FIG. 2, the net effect is degraded trans-hybrid rejection, but for the opposite reason. One subtlety is that since Z2 is much higher impedance than either Zsrc or the line impedance, Zleak2 has only a very small effect in causing further droop in the signal at V2.

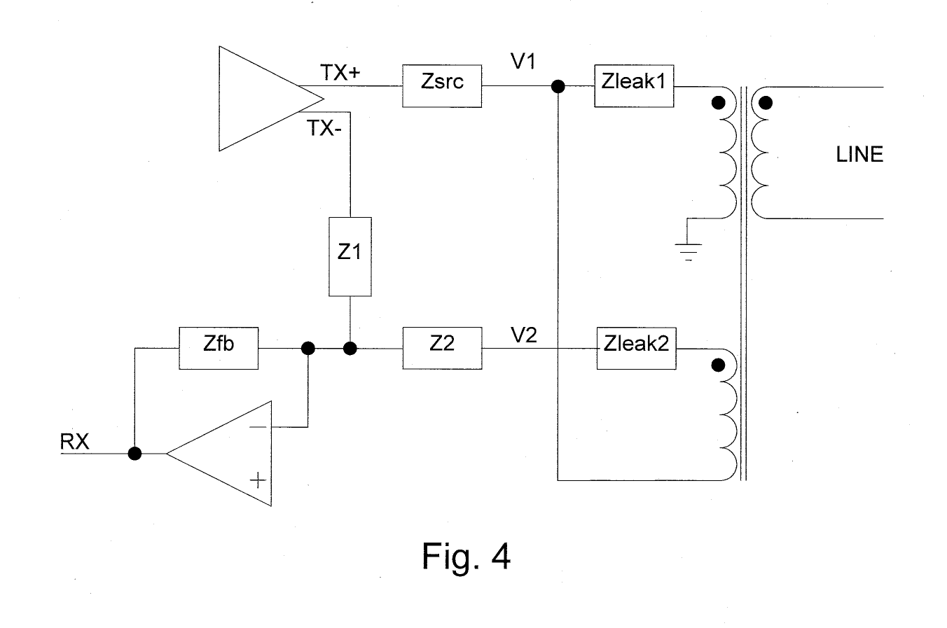

FIG. 4 shows one solution, and is one aspect of the current invention.

The receive winding is stacked on top of the transmit winding, the two being wired in series and in phase. Z2 is scaled by approximately half so as to maintain the same receive gain. As previously described, while transmitting higher frequencies, V1 tilts up and V2 droops with respect to TX+. This applies to both magnitude and phase.

For purposes of discussion, assume that the transmit and receive windings have the same number of turns, and provide the same mid-band and low-band frequency response. The high frequency response is different however: one droops and the other tilts up.

With the novel arrangement shown here, the tilt and droop partially counteract each other, so that the combined signal at V2 is much flatter. This approach is possible because, due to the galvanically isolated nature of transformer windings, arbitrary reference points don't appreciably alter their responses. In other words, stacked windings behave essentially the same as unstacked windings.

It should be noted that the droop and tilt curves are not exactly equal. The phase is usually more symmetrically equal-but-opposite than the magnitude. The complex response curves depend on exact circuit values and the exact design and construction of the transformer. But if these parameters are controlled sensibly and within economic feasibility, then the cancellation of tilt and droop helps the hybrid rejection significantly.

It will be obvious to those skilled in the art that in a balanced differential implementation, the receive winding would split into two halves and connected on either side of the transmit winding.

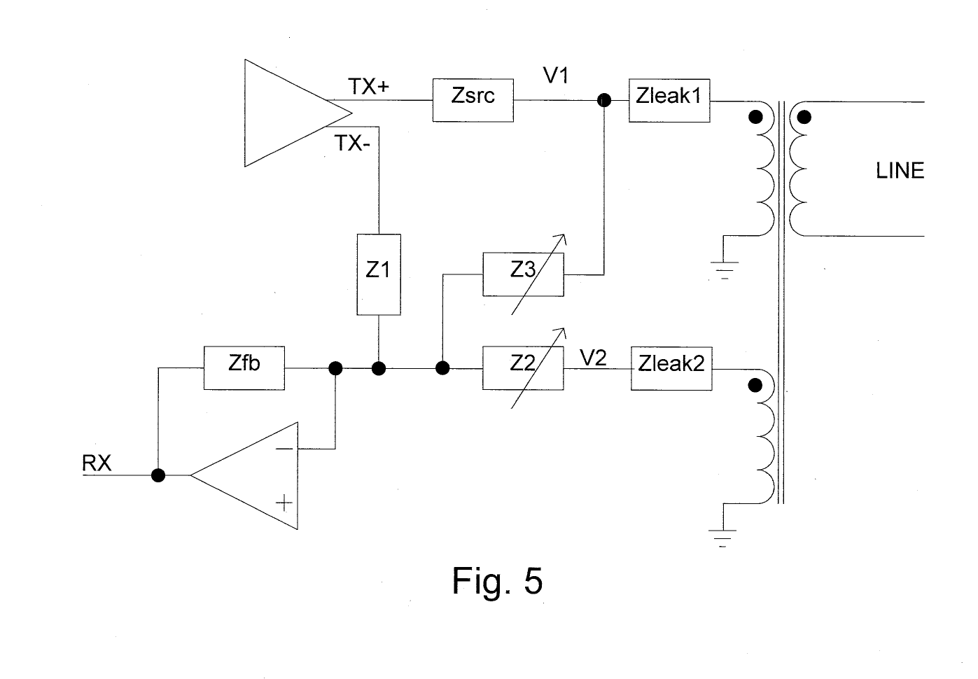

FIG. 5 shows another solution and is another aspect of the current invention.

Rather than stacking the receive and transmit windings for series summation, instead they are each used as independent sources into the summing junction of the receive amp. If Z2 and Z3 are equal, then an equal proportion of V1 and V2 are summed, which gives a very similar result to the circuit in FIG. 4.

However, this configuration allows more control. It allows an arbitrary frequency point within the droop/tilt range to be nulled at RX by finding the correct ratio of Z2 and Z3, as well as finding the exact scaling of Z2/Z3 to Z1. Two independent variables are used to get a match for both magnitude and phase. In practice the variable impedances Z2 and Z3 will be simple variable resistors.

One realization of this approach is to have Z2 and Z3 fixed so as to give a compromise best hybrid rejection for a given design.

Another realization, and certainly more powerful, is to have system software tune the variable resistances Z2 and Z3 so that best hybrid rejection can be found for a given frequency under different line conditions, as well as to compensate for component variations, especially the transformer where leakage inductance is hard to control tightly.

The embodiment of FIG. 4 provides better hybrid rejection than prior art methods FIG. 2 or 3. In systems with a variable capacitance hybrid rejection tuning mechanism, the inherently better rejection (without tuning) will give the tuning mechanism more range and therefore be more effective. However, this embodiment requires a separate receive winding and associated pins, which is some additional cost (but minimal). A separate receive winding with a different number of turns than the transmit winding would not offer as much help in offsetting tilt. It might have too much or not enough.

The embodiment of FIG. 5 has all the same advantages of FIG. 4. It compensates for part-to-part variation in transformer leakage inductance. A hybrid tuning mechanisms comprised of variable resistors for Z2 and Z3 works more powerfully, over a broader range, than the traditional variable capacitance method. Moreover, the receive winding does not have to have the same number of turns as the transmit winding. Meanwhile, the embodiment of FIG. 5 requires a separate receive winding and associated pins, which is some additional cost (but minimal). It also exhibits slightly higher thermal noise than FIG. 2, 3, or 4 due to the extra resistor feeding the summing junction.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed:

1. A hybrid circuit for improving hybrid rejection, comprising:
a transmit port for transmitting a transmit signal;
a receive port for receiving a receive signal;
a differential amplifier, wherein the output of the differential amplifier is connected to the receive port;
a transformer having a receive winding corresponding to the receive port and a transmit winding corresponding to the transmit port, wherein the receive winding is stacked on top of the transmit winding.

2. The hybrid circuit of claim 1, wherein the transmit winding and the receive winding are wired in series and in phase around a single core.

3. The hybrid circuit of claim 1, wherein the first end of the receive winding is connected to a summing junction of the differential amplifier through an impedance Z2, the other end of the receive winding is connected to a junction of the first end of the transmit winding and a back matching impedance Zsrc which in turn is connected to the transmit signal at the transmit port, and a signal with opposite polarity to the transmit signal is connected to the summing junction of the differential amplifier through an impedance Z1.

4. The hybrid circuit of claim 3, wherein Z2 is scaled by approximately half of Z1 so as to maintain the same receive gain.

5. The hybrid circuit of claim 2, wherein the receive winding is split into two halves and connected on either side of the transmitting winding.

6. A hybrid circuit for improving hybrid rejection, comprising:
a transmit port for transmitting a transmit signal;
a receive port for receiving a receive signal;
a differential amplifier, wherein the output of the differential amplifier is connected to the receive port;
a transformer having a receive winding corresponding to the receive port and a transmit winding corresponding to the transmit port, wherein the transmit winding and the receive winding are wired separately.

7. The hybrid circuit of claim 6, wherein the transmit winding and the receive winding are wired but in phase around a single core.

8. The hybrid circuit of claim 6, wherein the first end of the receive winding is connected to a summing junction of the differential amplifier through a variable impedance Z2, the other end of the receive winding is connected to the ground, the first end of the transmit winding is connected to a junction of a back matching impedance Zsrc and a variable impedance Z3, the Zsrc is in turn connected to the transmit port, the Z3 is in turn connected to the summing junction of the differential amplifier, and a signal with opposite polarity of the transmit signal is connected to the summing junction of the differential amplifier through an impedance Z1.

9. The hybrid circuit of claim 8, wherein the ratio of Z2 and Z3 are adjustable to allow an arbitrary frequency point within a predefined droop/tilt range to be nulled at the receive port.

10. The hybrid circuit of claim 8, wherein the Z2 and Z3 are variable resistors.

11. The hybrid circuit of claim 8, wherein the Z2 and Z3 can be fixed.

12. The hybrid circuit of claim 8, wherein the variable resistances of Z2 and Z3 are programmable to allow for best hybrid rejection for a given frequency, line conditions and component variations.
